(19) United States
(12) Patent Application Publication
(10) Pub. No.: US 2012/0313458 A1
(43) Pub. Date: Dec. 13, 2012

(54) Ironless Electrical Machines with Eddy Current Reducer

(76) Inventor: Alexei Stadnik, Beverly Hills, CA (US)

(21) Appl. No.: 13/509,774

(22) PCT Filed: Nov. 10, 2010
(86) PCT No.: PCT/US10/56103

§ 371 Date: May 14, 2012

Related U.S. Application Data
(60) Provisional application No. 61/281,173, filed on Nov. 14, 2009.

(51) Int. Cl. H02K 1/06; H02K 21/12; H02K 41/02

(52) U.S. Cl. 310/12.24; 310/10; 310/156.01

(57) ABSTRACT

The invention provides ironless electrical machines with reducer of Eddy current losses (Eddy current reducer) that improves the performance of machine. In the electromechanical systems with ironless electrical machines, it greatly reduces the Eddy current losses in moving conductive part from stationary permanent magnets (or in stationary conductive part from moving magnets).

### BACKGROUND OF THE INVENTION

The problem of Eddy current losses in the electromechanical systems with ironless electrical machines is well known. Some way for solving the problem is described in “Design and Test of an Ironless, Three Degree-of-Freedom, Magnetically Levitated. Linear Actuator with Moving Magnets” by J. V. Jansen, etc.—2005 IEEE International Conference on Electric Machines and Drives. For reduction of Eddy current losses the ceramic plate is used. The plate increase the distance between stationary and moving conductive part. This way is increasing electrical machine envelope. When using thick and strong magnets or go to high speed (several meter per second) the thickness of ceramic plate and therefore electrical machine envelope increase dramatically (the dimensions of ceramic plate can be several times more than original electrical machine envelope).

### DESCRIPTION OF THE FIGURES

FIG. 1.1—Linear flat ironless electric machine with forcer that includes coils and aluminum lamination or ceramic plate.

FIG. 1.2—Linear flat ironless electric machine with forcer that includes coils and aluminum lamination or ceramic plate mounted on the table top.

FIG. 1.3—The invented construction of linear flat ironless electric machine with forcer that includes coils and aluminum lamination or ceramic plate and Eddy current reducer.

FIG. 1.4—The invented linear flat ironless electric machine with forcer that includes coils and aluminum lamination or ceramic plate and Eddy current reducer mounted on the table top.

FIG. 2—The Eddy current reducer (for flat linear machine)

FIG. 3.1—Linear flat ironless electric machine with forcer that includes coils only.

FIG. 3.2—Linear flat ironless electric machine with forcer that includes coils only mounted on the table top.

FIG. 3.3—The invented construction of linear flat ironless electric machine with forcer that includes coils and Eddy current reducer.

FIG. 3.4—The invented linear flat ironless electric machine with forcer that includes coils and Eddy current reducer mounted on the table top.

FIG. 4.1—Linear flat ironless electric machine with forcer that includes coils, aluminum lamination or ceramic plate and aluminum base.

FIG. 4.2—The invented construction of linear flat ironless electric machine with forcer that includes coils, aluminum lamination or ceramic plate, Eddy current reducer and aluminum base.

FIG. 5.1—Linear flat ironless electric machine with forcer that includes coils and aluminum base.

FIG. 5.2—The invented construction of linear flat ironless electric machine with forcer that includes coils, Eddy current reducer and aluminum base.

FIG. 6.1—Linear tube (magnet inside) ironless electric machine with forcer that includes coils, aluminum lamination or ceramic and aluminum housing.

FIG. 6.2—The invented construction of linear tube (magnet inside) ironless electric machine with forcer that includes coils, aluminum lamination or ceramic, Eddy current reducer and aluminum housing.

FIG. 7—The Eddy current reducer (for tube linear machine).

FIG. 8.1—Linear tube (magnet inside) ironless electric machine with forcer that includes coils and aluminum housing.

FIG. 8.2—Linear tube (magnet inside) ironless electric machine with forcer that includes coils, Eddy current reducer and aluminum housing.

FIG. 9.1—Linear tube (coil inside) ironless electric machine with forcer that includes coils, aluminum lamination or ceramic and aluminum housing.

FIG. 9.2—Linear tube (coil inside) ironless electric machine with forcer that includes coils, aluminum lamination or ceramic, Eddy current reducer and aluminum housing.

FIG. 10.1—Linear tube (coil inside) ironless electric machine with forcer that includes coils and aluminum housing.

FIG. 10.2—Linear tube (coil inside) ironless electric machine with forcer that includes coils, Eddy current reducer and aluminum housing.

FIG. 11.1—Rotary ironless electric machine with internal rotor and stator that includes coils and aluminum lamination or ceramic.

FIG. 11.2—Rotary ironless electric machine with internal rotor and stator that includes coils and aluminum lamination or ceramic mounted to the custom housing.

FIG. 11.3—Rotary ironless electric machine with internal rotor and stator that includes coils, aluminum lamination or ceramic and Eddy current reducer.

FIG. 11.4—Rotary ironless electric machine with internal rotor and stator that includes coils, aluminum lamination or ceramic and Eddy current reducer mounted to the custom housing.

FIG. 12—The Eddy current reducer (for radial rotary machine).

FIG. 13.1—Rotary ironless electric machine with internal rotor and stator that includes coils only.

FIG. 13.2—Rotary ironless electric machine with internal rotor and stator that includes coils only mounted to the custom housing.

FIG. 13.3—Rotary ironless electric machine with internal rotor and stator that includes coils and Eddy current reducer.

FIG. 13.4—Rotary ironless electric machine with internal rotor and stator that includes coils and Eddy current reducer mounted to the custom housing.

FIG. 14.1—Rotary ironless electric machine with internal rotor and stator that includes coils, aluminum lamination or ceramic and aluminum housing.

FIG. 14.2—Rotary ironless electric machine with internal rotor and stator that includes coils, aluminum lamination or ceramic Eddy current reducer and aluminum housing.

FIG. 15.1—Rotary ironless electric machine with internal rotor and stator that includes coils and aluminum housing.

FIG. 15.2—Rotary ironless electric machine with internal rotor and stator that includes coils, Eddy current reducer and aluminum housing.

FIG. 16.1—Rotary ironless electric machine with external rotor and stator that includes coils and aluminum lamination or ceramic.

FIG. 16.2—Rotary ironless electric machine with external rotor and stator that includes coils and aluminum lamination or ceramic mounted to the custom housing.

FIG. 16.3—Rotary ironless electric machine with external rotor and stator that includes coils, aluminum lamination or ceramic Eddy current reducer.

FIG. 16.4—Rotary ironless electric machine with external rotor and stator that includes coils, aluminum lamination or ceramic and Eddy current reducer mounted to the custom housing.

FIG. 17.1—Rotary ironless electric machine with external rotor and stator that includes coils only.

FIG. 17.2—Rotary ironless electric machine with external rotor and stator that includes coils only mounted to the custom housing.

FIG. 17.3—Rotary ironless electric machine with external rotor and stator that includes coils and Eddy current reducer.

FIG. 17.4—Rotary ironless electric machine with external rotor and stator that includes coils and Eddy current reducer mounted to the custom housing.

FIG. 18.1—Rotary ironless electric machine with external rotor and stator that includes coils, aluminum lamination or ceramic and aluminum housing.

FIG. 18.1—Rotary ironless electric machine with external rotor and stator that includes coils, aluminum lamination or ceramic, aluminum housing and Eddy current reducer.

FIG. 19.1—Rotary ironless electric machine with external rotor and stator that includes coils and aluminum housing.

FIG. 19.2—Rotary ironless electric machine with external rotor and stator that includes coils, aluminum housing and Eddy current reducer.

FIG. 20.1—Rotary axial ironless electric machine with stator that includes coils and aluminum lamination or ceramic.

FIG. 20.2—Rotary axial ironless electric machine with stator that includes coils and aluminum lamination or ceramic mounted to the custom housing.

FIG. 20.3—Rotary axial ironless electric machine with stator that includes coils, aluminum lamination or ceramic and Eddy current reducer.

FIG. 20.4—Rotary axial ironless electric machine with stator that includes coils, aluminum lamination or ceramic and Eddy current reducer mounted to the custom housing.

FIG. 21—The Eddy current reducer (for axial rotary machine).

FIG. 22.1—Rotary axial ironless electric machine with stator that includes coils only.

FIG. 22.2—Rotary axial ironless electric machine with stator that includes coils only mounted to the custom housing.

FIG. 22.3—Rotary axial ironless electric machine with stator that includes coils and Eddy current reducer.

FIG. 22.4—Rotary axial ironless electric machine with stator that includes coils and Eddy current reducer mounted to the custom housing.

FIG. 23.1—Rotary axial ironless electric machine with stator that includes coils, aluminum lamination or ceramic and aluminum housing.

FIG. 23.2—Rotary axial ironless electric machine with stator that includes coils, aluminum lamination or ceramic, aluminum housing and Eddy current reducer.

FIG. 24.1—Rotary axial ironless electric machine with stator that includes coils and aluminum housing.

FIG. 24.2—Rotary axial ironless electric machine with stator that includes coils, aluminum housing and Eddy current reducer.

### REFERENCE NUMERALS

10—ironless forcer that includes coils and aluminum lamination or ceramic plate (flat linear machine)
11—coils (flat linear machine)
12—epoxy
14—aluminum lamination or ceramic plate (flat linear machine)
16—magnet track (flat linear machine)
18—magnetic plate (flat linear machine)
20—magnets (flat linear machine)
22—ironless conductive table top
24—Eddy current reducer (flat linear machine)
26—ironless forcer that includes coils, aluminum lamination or ceramic plate and Eddy current reducer (flat linear machine)
28—pieces of ferromagnetic material or compound
30—non-magnetic spacers
32—ironless forcer that includes coils only (flat linear machine)
38—ironless forcer that includes coils and Eddy current reducer (flat linear machine)
40—ironless forcer that includes coils, aluminum lamination or ceramic plate and aluminum base (flat linear machine)
42—aluminum base (flat linear machine)
50—ironless forcer that includes coils, aluminum lamination or ceramic and housing (tube linear machine, magnets inside)
52—coils (tube linear machine, magnets inside)
54—aluminum lamination or ceramic (tube linear machine, magnets inside)
56—housing (tube linear machine, magnets inside)
60—magnet track (tube linear machine, magnets inside)
62—forcer (tube linear machine, magnets inside)
64—magnets (tube linear machine, magnets inside)
66—ironless forcer that includes coils, aluminum lamination or ceramic, housing and Eddy current reducer (tube linear machine, magnets inside)
68—Eddy current reducer (tube linear machine)
70—pieces of ferromagnetic material or compound
72—non-magnetic spacers
74—ironless forcer that includes coils and housing (tube linear machine, magnets inside)
76—ironless forcer that includes coils, housing and Eddy current reducer (tube linear machine, magnets inside)
78—ironless forcer that includes coils, aluminum lamination or ceramic and base (tube linear machine, coils inside)
80—coils (tube linear machine, coils inside)
82—epoxy
84—aluminum lamination or ceramic (tube linear machine, coils inside)
86—aluminum base (tube linear machine, coils inside)
88—magnet track (tube linear machine, coils inside)
90—magnets (tube linear machine, coils inside)
92—housing (tube linear machine, coils inside)
94—ironless forcer that includes coils, aluminum lamination or ceramic, base and Eddy current reducer (tube linear machine, coils inside)
96—ironless forcer that includes coils and base (tube linear machine, coils inside)
98—ironless forcer that includes coils, base and Eddy current reducer (tube linear machine, coils inside)
100—ironless stator that includes coils and aluminum lamination or ceramic (rotary machine, internal rotor)
102—coils (rotary machine)
104—epoxy
106—stack of aluminum laminations or ceramic (rotary machine, internal rotor)
108—internal rotor (rotary machine)
110—bushing (rotary machine, internal rotor)
112—magnets (rotary machine, internal rotor)
114—custom housing (rotary machine, internal rotor)
116—ironless stator that includes coils, aluminum lamination or ceramic and Eddy current reducer (rotary machine, internal rotor)
118—Eddy current reducer (radial rotary machine)
119—pieces of ferromagnetic material or compound
120—non-magnetic spacers
121—ironless stator that includes coils only (rotary machine, internal rotor)
122—ironless stator that includes coils and Eddy current reducer (rotary machine, internal rotor)
124—ironless stator that includes coils, aluminum lamination or ceramic and aluminum housing (rotary machine, internal rotor)
126—aluminum housing (rotary machine, internal rotor)
128—ironless stator that includes coils, aluminum lamination or ceramic, Eddy current reducer and aluminum housing (rotary machine, internal rotor)
130—ironless stator that includes coils and aluminum housing (rotary machine, internal rotor)
132—ironless stator that includes coils, Eddy current reducer and aluminum housing (rotary machine, internal rotor)
134—ironless stator that includes coils and aluminum lamination or ceramic (rotary machine, external rotor)
136—stack of aluminum laminations or ceramic (rotary machine, external rotor)
138—external rotor (rotary machine)
140—bushing (rotary machine, external rotor)
142—magnets (rotary machine, external rotor)
144—custom housing (rotary machine, external rotor)
146—ironless stator that includes coils, aluminum lamination or ceramic and Eddy current reducer (rotary machine, external rotor)
148—ironless stator that includes coils only (rotary machine, external rotor)
150—ironless stator that includes coils and Eddy current reducer (rotary machine, external rotor)
152—ironless stator that includes coils, aluminum lamination or ceramic and aluminum housing (rotary machine, external rotor)
154—aluminum housing (rotary machine, external rotor)
156—ironless stator that includes coils, aluminum lamination or ceramic, Eddy current reducer and aluminum housing (rotary machine, external rotor)
158—ironless stator that includes coils and aluminum housing (rotary machine, external rotor)
160—ironless stator that includes coils, Eddy current reducer and aluminum housing (rotary machine, external rotor)
162—ironless stator that includes coils and aluminum lamination or ceramic (rotary axial machine)
164—coils (rotary axial machine)
166—epoxy
168—stack of aluminum laminations or ceramic (rotary axial machine)
170—rotor (rotary axial machine)
172—magnetic plate (rotary axial machine)
174—magnets (rotary axial machine)
176—custom housing (rotary axial machine)
178—ironless stator that includes coils, aluminum lamination or ceramic and Eddy current reducer (rotary axial machine)
180—Eddy current reducer (rotary axial machine)
182—pieces of ferromagnetic material or compound
184—non-magnetic spacers
186—ironless stator that includes coils only (rotary axial machine)
188—ironless stator that includes coils and Eddy current reducer (rotary axial machine)
190—ironless stator that includes coils, aluminum lamination or ceramic and aluminum housing (rotary axial machine)
192—aluminum housing (rotary axial machine)
194—ironless stator that includes coils, aluminum lamination or ceramic, aluminum housing and Eddy current reducer (rotary axial machine)
196—ironless stator that includes coils and aluminum housing (rotary axial machine)
198—ironless stator that includes coils, aluminum housing and Eddy current reducer (rotary axial machine)

### DESCRIPTION OF THE PREFERRED EMBODIMENT

Linear Flat Ironless Electric Machine with Forcer that Includes Coils and Aluminum Lamination or Ceramic Plate.

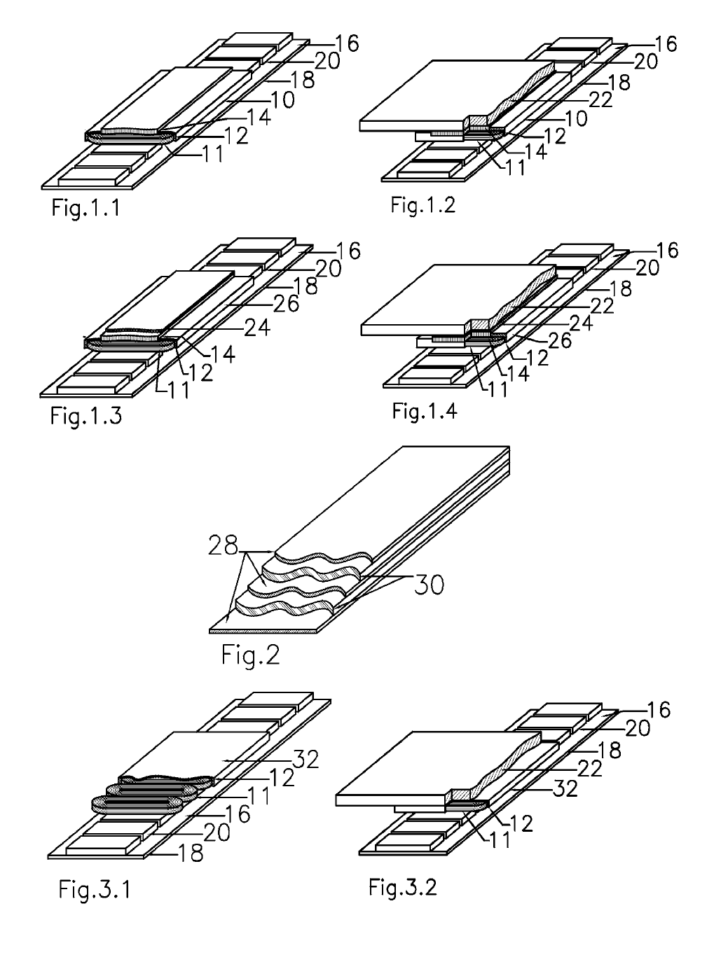

Linear flat ironless electric machine with forcer that includes coils and aluminum lamination or ceramic plate is shown on FIG. 1.1. Ironless forcer 10 consists of coils 11 encapsulated in epoxy 12 and stack of aluminum laminations or ceramic plate 14. Magnet track 16 consists of magnetic plate 18 and magnets 20. Eddy current losses in forcer are very low.

However the forcer needs to be mounted to mechanical structure (FIG. 1.2). When forcer is mounted to the table top 22 (usually made of conductive material, for example, aluminum) the Eddy current losses will occur in the table top.

The invented linear flat ironless electric machine construction includes forcer 26 consisted of coils 11 encapsulated in epoxy 12, stack of aluminum lamination or ceramic plate 14 and Eddy current reducer 24 (FIG. 1.3). The reducer is installed on the forcer of ironless electric machine at the side opposite to magnets (or between conductive part, where eddy current losses are occurring and coils with aluminum lamination and/or ceramic). Reducer prevents Eddy current losses in the table top.

The Eddy current reducer for flat linear machine is shown on FIG. 2. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 28 are divided one from another by non-magnetic spacers 30. The thickness of pieces is 0.010-1.0 mm each (or other depending on applications). The exact dimensions and quantity of pieces depend on electromechanical design and are subject for optimization.

The invented design of linear flat ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant magnetic attraction and cogging. The Eddy current reducer finally reduces eddy current losses in table top 22 (FIG. 1.4).

Linear Flat Ironless Electric Machine with Forcer that Includes Coils Only.

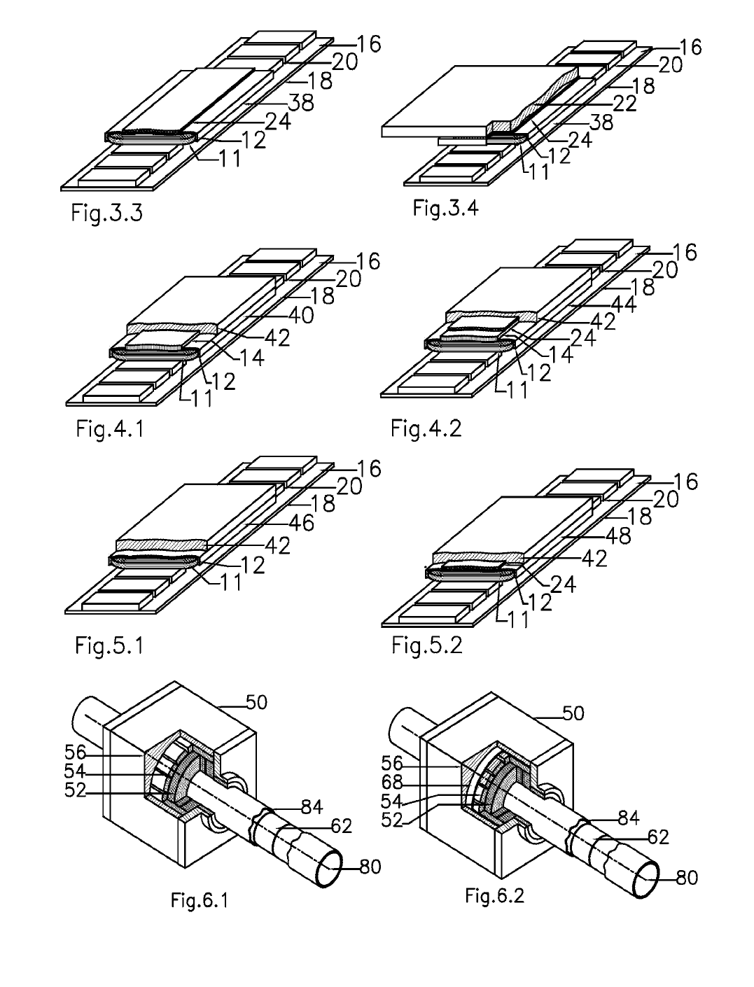

Linear flat ironless electric machine with forcer that includes coils only is shown on FIG. 3.1. Ironless forcer 32 consists of coils 11 encapsulated in epoxy 12. Magnet track 16 consists of magnetic plate 18 and magnets 20. Eddy current losses in forcer are very low.

However the forcer needs to be mounted to mechanical structure (FIG. 3.2). When forcer is mounted to the table top 22 (usually made of conductive material, for example, aluminum) the Eddy current losses will occur in the table top.

The invented linear flat ironless electric machine construction includes forcer 38 consisted of coils 11 encapsulated in epoxy 12 and Eddy current reducer 24 (FIG. 3.3). The reducer is installed on the forcer of ironless electric machine at the side opposite to magnets (or between conductive part, where eddy current losses are occurring and coils). Reducer prevents Eddy current losses in the table top.

The Eddy current reducer for flat linear machine is shown on FIG. 2. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 28 divided one from another by non-magnetic spacers 30. The thickness of pieces is 0.010-1.0 mm each (or other depending on applications). The exact dimensions and quantity of pieces depend on electromechanical design and are subject for optimization.

The invented design of linear flat ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant magnetic attraction and cogging. The Eddy current reducer finally reduces eddy current losses in table top 22 (FIG. 3.4).

Linear Flat Ironless Electric Machine with Forcer that Includes Coils, Aluminum Lamination or Ceramic Plate and Aluminum Base.

Linear flat ironless electric machine with forcer that includes coils, aluminum lamination or ceramic plate and aluminum base is shown on FIG. 4.1. Ironless forcer 40 consists of coils 11 encapsulated in epoxy 12, stack of aluminum laminations or ceramic plate 14 and aluminum base 42. Magnet track 16 consists of magnetic plate 18 and magnets 20. During machine moving the Eddy current losses will occur in the aluminum base.

The invented linear flat ironless electric machine construction includes forcer 44 consisted of coils 11 encapsulated in epoxy 12, stack of aluminum lamination or ceramic plate 14, aluminum base 42 and Eddy current reducer 24 (FIG. 4.2). The reducer is installed into the forcer of ironless electric machine between aluminum base, where Eddy current losses are occurring and coils with aluminum lamination and/or ceramic. Reducer prevents Eddy current losses in the aluminum base.

The Eddy current reducer for flat linear machine is shown on FIG. 2. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 28 are divided one from another by non-magnetic spacers 30. The thickness of pieces is 0.010-1.0 mm each (or other depending on applications). The exact dimensions and quantity of pieces depend on electromechanical design and are subject for optimization.

The invented design of linear flat ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant magnetic attraction and cogging. The Eddy current reducer finally reduces eddy current losses in the aluminum base 42.

Linear Flat Ironless Electric Machine with Forcer that Includes Coils and Aluminum Base.

Linear flat ironless electric machine with forcer that includes coils and aluminum base is shown on FIG. 5.1. Ironless forcer 46 consists of coils 11 encapsulated in epoxy 12 and aluminum base 42. Magnet track 16 consists of magnetic plate 18 and magnets 20. During machine moving the Eddy current losses will occur in the aluminum base.

The invented linear flat ironless electric machine construction includes forcer 48 consisted of coils 11 encapsulated in epoxy 12, aluminum base 42 and Eddy current reducer 24 (FIG. 5.2). The reducer is installed into the forcer of ironless electric machine between aluminum base, where Eddy current losses are occurring and coils with aluminum lamination and/or ceramic. Reducer prevents Eddy current losses in the aluminum base.

The Eddy current reducer for flat linear machine is shown on FIG. 2. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 28 are divided one from another by non-magnetic spacers 30. The thickness of pieces is 0.010-1.0 mm each (or other depending on applications). The exact dimensions and quantity of pieces depend on electromechanical design and are subject for optimization.

The invented design of linear flat ironless electric machine not only reduces the module of magnetic field in conductive part but it also greatly reduces the normal component of magnetic field which creates Eddy current (thereby the tangential component may increase but it do not create Eddy currents). Due to this feature, the very thin and magnetically saturated eddy current reducer has insignificant magnetic attraction and togging. The Eddy current reducer finally reduces eddy current losses in the aluminum base 42.

Linear Tube (Magnet Inside) Ironless Electric Machine with Forcer that Includes Coils, Aluminum Lamination or Ceramic and Aluminum Housing.

Linear tube (magnet inside) ironless electric machine with forcer that includes coils, aluminum lamination or ceramic and aluminum housing is shown on FIG. 6.1. Ironless forcer 50 consists of coils 52, stack of aluminum laminations or ceramic 54 and aluminum housing 56. Magnet track 60 consists of magnets 62 placed inside tube 64. During machine moving the Eddy current losses will occur in the aluminum housing.

The invented linear tube (magnet inside) ironless electric machine construction includes forcer 66 consisted of coils 52, stack of aluminum lamination or ceramic 54, aluminum housing 56, and Eddy current reducer 68 (FIG. 6.2). The reducer is installed inside the forcer of ironless electric machine between aluminum housing, where Eddy current losses are occurring and coils with aluminum lamination and/or ceramic. Reducer prevents Eddy current losses in the aluminum housing.

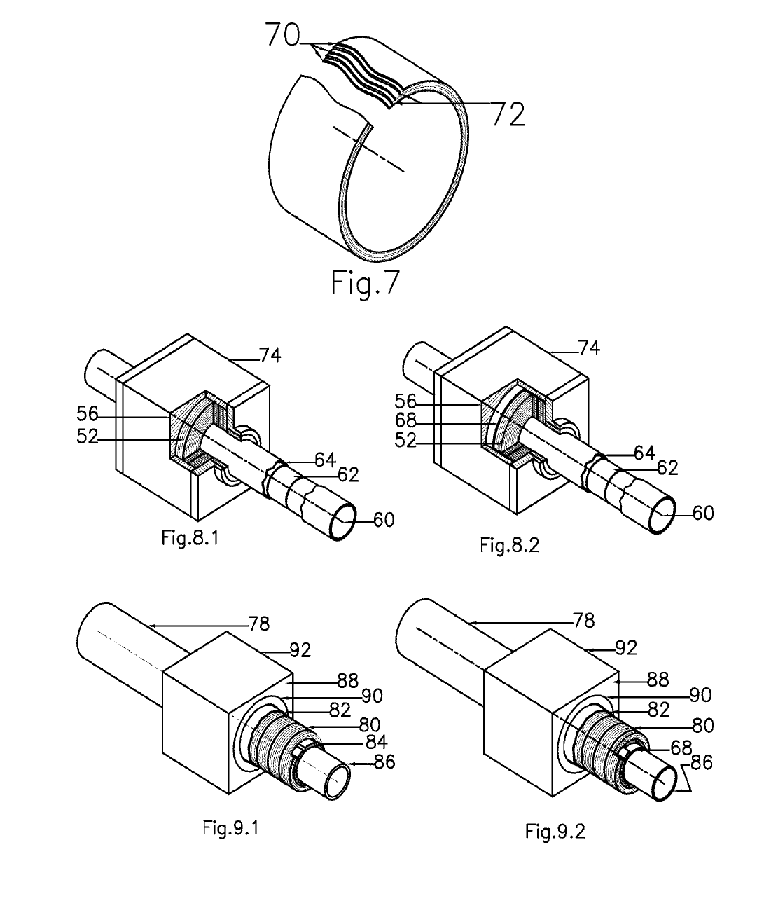

The Eddy current reducer for tube linear machine is shown on FIG. 7. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 70 are divided one from another by non-magnetic spacers 72. The thickness of pieces is 0.010-1.0 mm each (or other depending on applications). The exact dimensions and quantity of pieces depend on electromechanical design and are subject for optimization.

The invented design of linear tube (magnet inside) ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant coping. The Eddy current reducer finally reduces eddy current losses in the aluminum housing 56.

Linear Tube (Magnet Inside) Ironless Electric Machine with Forcer that Includes Coils and Aluminum Housing.

Linear tube (magnet inside) ironless electric machine with forcer that includes coils and aluminum housing is shown on FIG. 8.1. Ironless forcer 74 consists of coils 52 and aluminum housing 56. Magnet track 60 consists of magnets 62 placed inside tube 64. During machine moving the Eddy current losses will occur in the aluminum housing.

The invented linear tube (magnet inside) ironless electric machine construction includes forcer 76 consisted of coils 52, aluminum housing 56, and Eddy current reducer 68 (FIG. 8.2). The reducer is installed inside the forcer of ironless electric machine between aluminum housing, where Eddy current losses are occurring and coils. Reducer prevents Eddy current losses in the aluminum housing.

The Eddy current reducer for tube linear machine is shown on FIG. 7. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 70 are divided one from another by non-magnetic spacers 72. The thickness of pieces is 0.010-1.0 mm each (or other depending on applications). The exact dimensions and quantity of pieces depend on electromechanical design and are subject for optimization.

The invented design of linear tube (magnet inside) ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant cogging. The Eddy current reducer finally reduces eddy current losses in the aluminum housing 56.

Linear Tube (Coil Inside) Ironless Electric Machine with Forcer that Includes Coils, Aluminum Lamination or Ceramic and Aluminum Base.

Linear tube (coil inside) ironless electric machine with forcer that includes coils, aluminum lamination or ceramic and aluminum base is shown on FIG. 9.1. Ironless forcer 78 consists of coils 80 encapsulated in epoxy 82, stack of aluminum laminations or ceramic 84 and aluminum base 86. Magnet track 88 consists of magnets 90 placed inside housing 92. During machine moving the Eddy current losses will occur in the aluminum base.

The invented linear tube (coil inside) ironless electric machine construction includes forcer 94 consisted of coils 80 encapsulated in epoxy 82, stack of aluminum lamination or ceramic 84, aluminum base 86, and Eddy current reducer 68 (FIG. 9.2). The reducer is installed inside the forcer of ironless electric machine between aluminum base, where Eddy current losses are occurring and coils with aluminum lamination and/or ceramic. Reducer prevents Eddy current losses in the aluminum base.

The Eddy current reducer for tube linear machine is shown on FIG. 7. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 70 are divided one from another by non-magnetic spacers 72. The thickness of pieces is 0.010-1.0 mm each (or other depending on applications). The exact dimensions and quantity of pieces depend on electromechanical design and are subject for optimization.

The invented design of linear tube (coil inside) ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant coping. The Eddy current reducer finally reduces eddy current losses in the aluminum base 86.

Linear Tube (Coil Inside) Ironless Electric Machine with Forcer that Includes Coils and Aluminum Base.

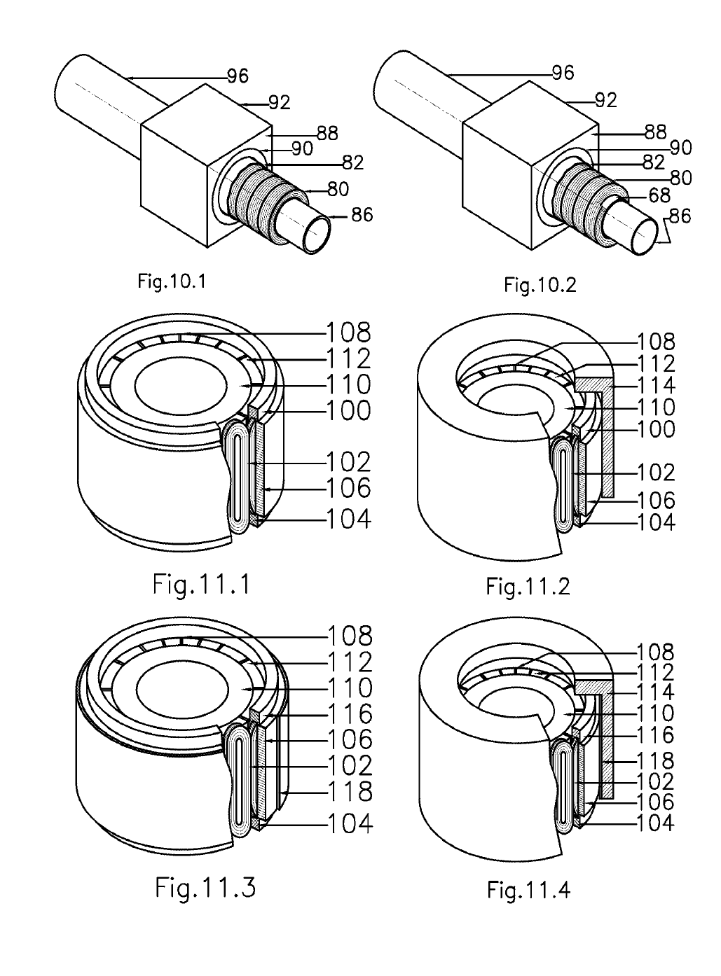

Linear tube (coil inside) ironless electric machine with forcer that includes coils and aluminum base is shown on FIG. 10.1. Ironless forcer 96 consists of coils 80 encapsulated in epoxy 82 and aluminum base 86. Magnet track 88 consists of magnets 90 placed inside housing 92. During machine moving the Eddy current losses will occur in the aluminum base.

The invented linear tube (coil inside) ironless electric machine construction includes forcer 98 consisted of coils 80 encapsulated in epoxy 82, aluminum base 86, and Eddy current reducer 68 (FIG. 102). The reducer is installed inside the forcer of ironless electric machine between aluminum base, where Eddy current losses are occurring and coils. Reducer prevents Eddy current losses in the aluminum base.

The Eddy current reducer for tube linear machine is shown on FIG. 7. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 70 are divided one from another by non-magnetic spacers 72. The thickness of pieces is 0.010-1.0 mm each (or other depending on applications). The exact dimensions and quantity of pieces depend on electromechanical design and are subject for optimization.

The invented design of linear tube (coil inside) ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant cogging. The Eddy current reducer finally reduces eddy current losses in the aluminum base 86.

Rotary Ironless Electric Machine with Internal Rotor and Stator that Includes Coils and Aluminum Lamination or Ceramic.

Rotary ironless electric machine with internal rotor and stator that includes coils and aluminum lamination or ceramic is shown on FIG. 11.1. Ironless stator 100 consists of coils 102 encapsulated in epoxy 104 and stack of aluminum laminations or ceramic 106. Internal rotor 108 consists of bushing 110 and magnets 112. Eddy current losses in stator are very low.

However the stator needs to be mounted to custom housing (FIG. 11.2). When stator is mounted to the custom housing 114 (usually made of conductive material, for example, aluminum) the Eddy current losses will occur in the housing.

The invented rotary ironless electric machine construction includes stator 116 consisted of coils 102 encapsulated in epoxy 104, stack of aluminum lamination or ceramic plate 106 and Eddy current reducer 118 (FIG. 11.3). The reducer is installed over the stator of ironless electric machine between conductive part, where Eddy current losses are occurring and coils with aluminum lamination and/or ceramic. Reducer prevents Eddy current losses in the custom housing.

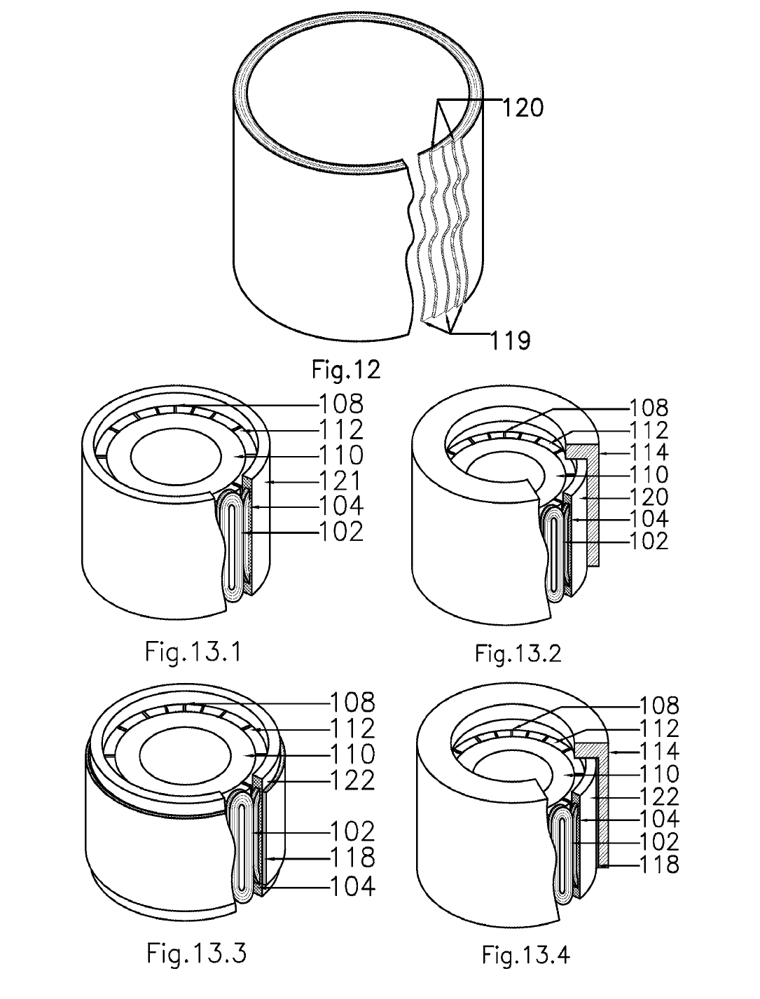

The Eddy current reducer for rotary machine is shown on FIG. 12. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 119 are divided one from another by non-magnetic spacers 120. The thickness of pieces is 0.010-1.0 mm each (or other depending on applications). The exact dimensions and quantity of pieces depend on electromechanical design and are subject for optimization.

The invented design of rotary ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in custom housing 114 (FIG. 11.4).

Rotary Ironless Electric Machine with Internal Rotor and Stator that Includes Coils Only.

Rotary ironless electric machine with internal rotor and stator that includes coils only is shown on FIG. 13.1. Ironless stator 121 consists of coils 102 encapsulated in epoxy 104. Internal rotor 108 consists of bushing 110 and magnets 112. Eddy current losses in stator are very low.

However the stator needs to be mounted to custom housing (FIG. 13.2). When stator is mounted to the custom housing 114 (usually made of conductive material, for example, aluminum) the Eddy current losses will occur in the housing.

The invented rotary ironless electric machine construction includes stator 122 consisted of coils 102 encapsulated in epoxy 104 and Eddy current reducer 118 (FIG. 13.3). The reducer is installed over the stator of ironless electric machine between conductive part, where Eddy current losses are occurring and coils. Reducer prevents Eddy current losses in the custom housing.

The Eddy current reducer for rotary machine is shown on FIG. 12. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 119 are divided one from another by non-magnetic spacers 120. The thickness of pieces is 0.010-1.0 mm each (or other depending on applications). The exact dimensions and quantity of pieces depend on electromechanical design and are subject for optimization.

The invented design of rotary ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in custom housing 114 (FIG. 13.4).

Rotary Ironless Electric Machine with Internal Rotor and Stator that Includes Coils, Aluminum Lamination or Ceramic and Aluminum Housing.

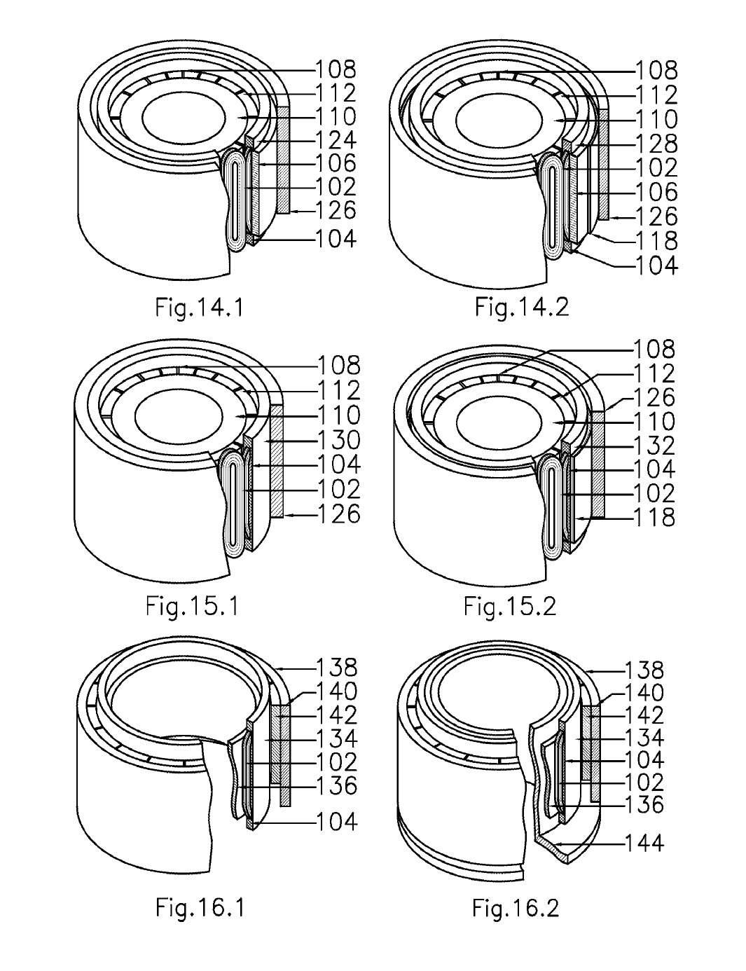

Rotary ironless electric machine with internal rotor and stator that includes coils, aluminum lamination or ceramic and aluminum housing is shown on FIG. 14.1. Ironless stator 124 consists of coils 102 encapsulated in epoxy 104, aluminum lamination or ceramic 106 and aluminum housing 126. Internal rotor 108 consists of bushing 110 and magnets 112. During machine rotating the Eddy current losses will occur in the aluminum housing.

The invented rotary ironless electric machine construction includes stator 128 consisted of coils 102 encapsulated in epoxy 104, aluminum lamination or ceramic 106, aluminum housing 126 and Eddy current reducer 118 (FIG. 14.2). The reducer is installed inside the stator of ironless electric machine between aluminum housing, where Eddy current losses are occurring and coils with aluminum lamination and/or ceramic. Reducer prevents Eddy current losses in the aluminum housing.

The Eddy current reducer for rotary machine is shown on FIG. 12. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 119 are divided one from another by non-magnetic spacers 120. The thickness of pieces is 0.010-1.0 mm each (or other depending on applications). The exact dimensions and quantity of pieces depend on electromechanical design and are subject for optimization.

The invented design of rotary ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in aluminum housing 126.

Rotary Ironless Electric Machine with Internal Rotor and Stator that Includes Coils and Aluminum Housing.

Rotary ironless electric machine with internal rotor and stator that includes coils and aluminum housing is shown on FIG. 15.1. Ironless stator 130 consists of coils 102 encapsulated in epoxy 104 and aluminum housing 126. Internal rotor 108 consists of bushing 110 and magnets 112. During machine rotating the Eddy current losses will occur in the aluminum housing.

The invented rotary ironless electric machine construction includes stator 132 consisted of coils 102 encapsulated in epoxy 104, aluminum housing 126 and Eddy current reducer 118 (FIG. 15.2). The reducer is installed inside the stator of ironless electric machine between aluminum housing, where Eddy current losses are occurring and coils. Reducer prevents Eddy current losses in the aluminum housing.

The Eddy current reducer for rotary machine is shown on FIG. 12. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 119 are divided one from another by non-magnetic spacers 120. The thickness of pieces is 0.010-1.0 mm each (or other depending on applications). The exact dimensions and quantity of pieces depend on electromechanical design and are subject for optimization.

The invented design of rotary ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in aluminum housing 126.

Rotary Ironless Electric Machine with External Rotor and Stator that Includes Coils and Aluminum Lamination or Ceramic.

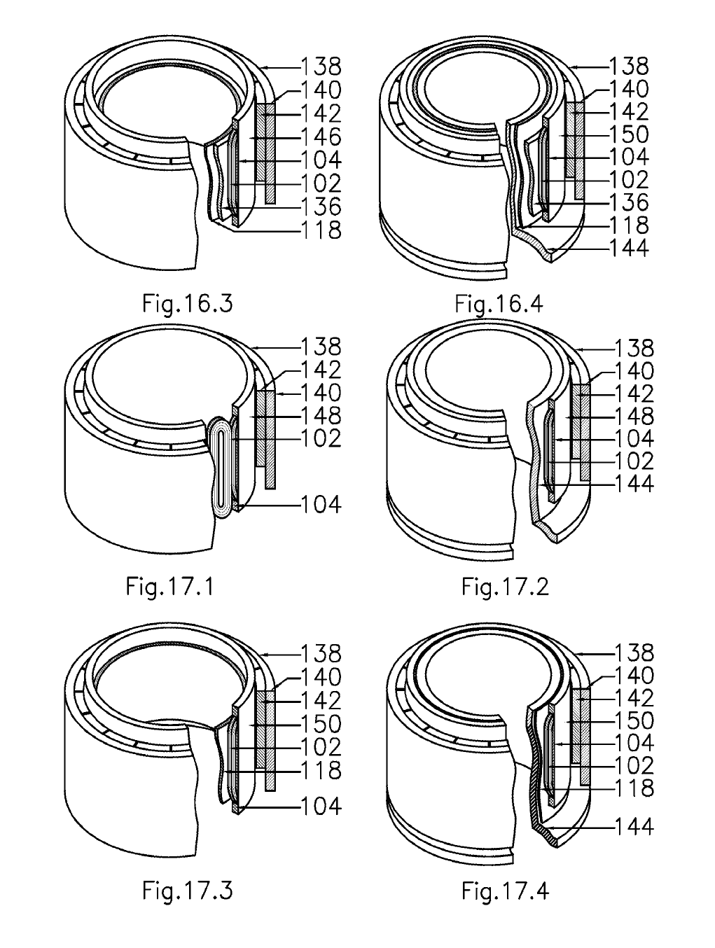

Rotary ironless electric machine with external rotor and stator that includes coils and aluminum lamination or ceramic is shown on FIG. 16.1. Ironless stator 134 consists of coils 102 encapsulated in epoxy 104 and stack of aluminum laminations or ceramic 136. External rotor 138 consists of bushing 140 and magnets 142. Eddy current losses in stator are very low.

However the stator needs to be mounted to custom housing (FIG. 16.2). When stator is mounted to the custom housing 144 (usually made of conductive material, for example, aluminum) the Eddy current losses will occur in the housing.

The invented rotary ironless electric machine construction includes stator 146 consisted of coils 102 encapsulated in epoxy 104, stack of aluminum lamination or ceramic plate 136 and Eddy current reducer 118 (FIG. 16.3). The reducer is installed inside the stator of ironless electric machine between conductive part, where Eddy current losses are occurring and coils with aluminum lamination and/or ceramic. Reducer prevents Eddy current losses in the custom housing.

The Eddy current reducer for rotary machine is shown on FIG. 12. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 119 are divided one from another by non-magnetic spacers 120. The thickness of pieces is 0.010-1.0 mm each (or other depending on applications). The exact dimensions and quantity of pieces depend on electromechanical design and are subject for optimization.

The invented design of rotary ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in custom housing 144 (FIG. 16.4).

Rotary Ironless Electric Machine with External Rotor and Stator that Includes Coils Only.

Rotary ironless electric machine with external rotor and stator that includes coils only is shown on FIG. 17.1. Ironless stator 148 consists of coils 102 encapsulated in epoxy 104. External rotor 138 consists of bushing 140 and magnets 142. Eddy current losses in stator are very low.

However the stator needs to be mounted to custom housing (FIG. 17.2). When stator is mounted to the custom housing 144 (usually made of conductive material, for example, aluminum) the Eddy current losses will occur in the housing.

The invented rotary ironless electric machine construction includes stator 150 consisted of coils 102 encapsulated in epoxy 104 and Eddy current reducer 118 (FIG. 17.3). The reducer is installed inside the stator of ironless electric machine between conductive part, where Eddy current losses are occurring and coils. Reducer prevents Eddy current losses in the custom housing.

The Eddy current reducer for rotary machine is shown on FIG. 12. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 119 are divided one from another by non-magnetic spacers 120. The thickness of pieces is 0.010-1.0 mm each (or other depending on applications). The exact dimensions and quantity of pieces depend on electromechanical design and are subject for optimization.

The invented design of rotary ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in custom housing 144 (FIG. 17.4).

Rotary Ironless Electric Machine with External Rotor and Stator that Includes Coils, Aluminum Lamination or Ceramic and Aluminum Housing.

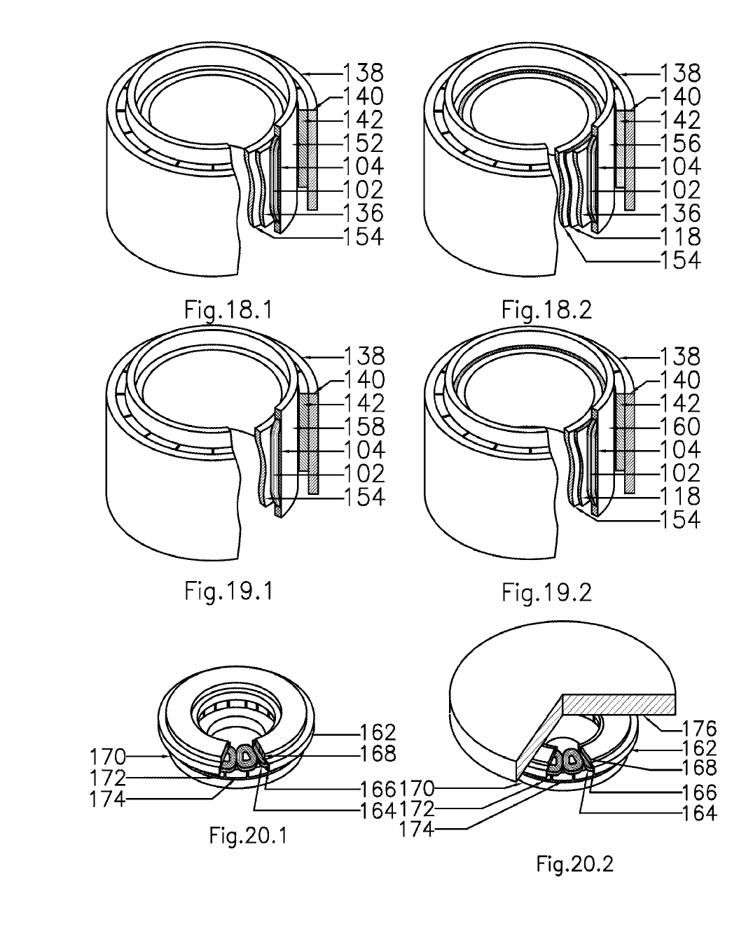

Rotary ironless electric machine with external rotor and stator that includes coils, aluminum lamination or ceramic and aluminum housing is shown on FIG. 18.1. Ironless stator 152 consists of coils 102 encapsulated in epoxy 104, aluminum lamination or ceramic 136 and aluminum housing 154. External rotor 138 consists of bushing 140 and magnets 142. During machine rotating the Eddy current losses will occur in the aluminum housing.

The invented rotary ironless electric machine construction includes stator 156 consisted of coils 102 encapsulated in epoxy 104, aluminum lamination or ceramic 136, aluminum housing 154 and Eddy current reducer 118 (FIG. 18.2). The reducer is installed inside the stator of ironless electric machine between aluminum housing, where Eddy current losses are occurring and coils with aluminum lamination and/or ceramic. Reducer prevents Eddy current losses in the aluminum housing.

The Eddy current reducer for rotary machine is shown on FIG. 12. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 119 are divided one from another by non-magnetic spacers 120. The thickness of pieces is 0.010-1.0 mm each (or other depending on applications). The exact dimensions and quantity of pieces depend on electromechanical design and are subject for optimization.

The invented design of rotary ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in aluminum housing 154.

Rotary Ironless Electric Machine with External Rotor and Stator that Includes Coils and Aluminum Housing.

Rotary ironless electric machine with external rotor and stator that includes coils and aluminum housing is shown on FIG. 19.1. Ironless stator 158 consists of coils 102 encapsulated in epoxy 104 and aluminum housing 154. External rotor 138 consists of bushing 140 and magnets 142. During machine rotating the Eddy current losses will occur in the aluminum housing.

The invented rotary ironless electric machine construction includes stator 160 consisted of coils 102 encapsulated in epoxy 104, aluminum housing 154 and Eddy current reducer 118 (FIG. 19.2). The reducer is installed inside the stator of ironless electric machine between aluminum housing, where Eddy current losses are occurring and coils. Reducer prevents Eddy current losses in the aluminum housing.

The Eddy current reducer for rotary machine is shown on FIG. 12. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 119 are divided one from another by non-magnetic spacers 120. The thickness of pieces is 0.010-1.0 mm each (or other depending on applications). The exact dimensions and quantity of pieces depend on electromechanical design and are subject for optimization.

The invented design of rotary ironless electric machine not only reduces the module of magnetic field in conductive part but it also greatly reduces the normal component of magnetic field which creates Eddy currents (thereby the tangential component may increase but it do not create Eddy currents). The Eddy current reducer finally reduces eddy current losses in aluminum housing 154.

Rotary Axial Ironless Electric Machine with Stator that Includes Coils and Aluminum Lamination or Ceramic.

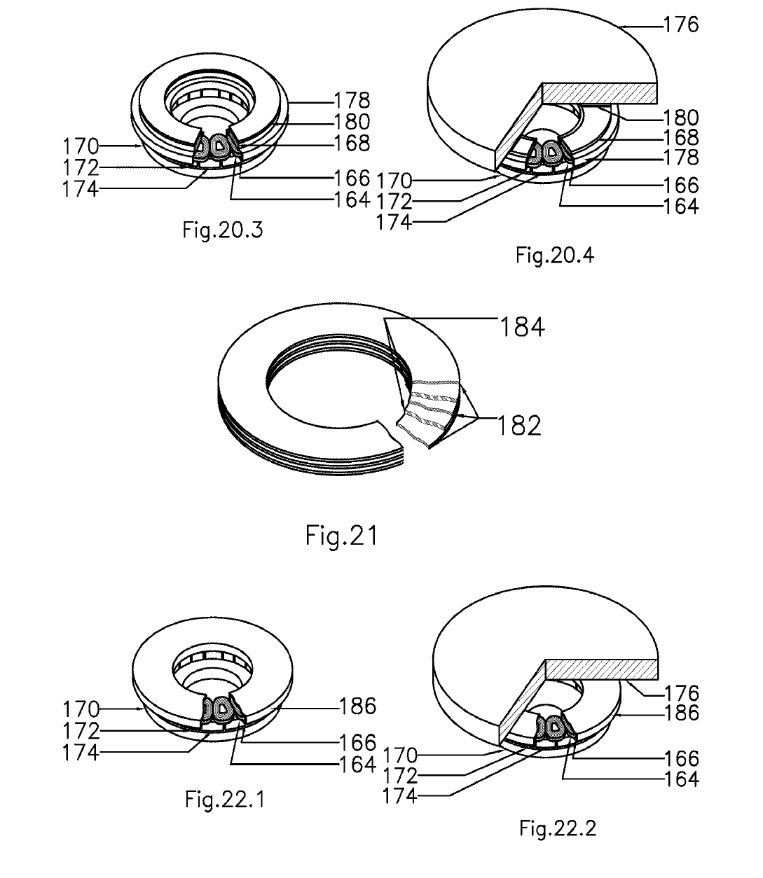

Rotary axial ironless electric machine with stator that includes coils and aluminum lamination or ceramic is shown on FIG. 20.1. Ironless stator 162 consists of coils 164 encapsulated in epoxy 166 and stack of aluminum laminations or ceramic 168. Rotor 170 consists of magnet plate 172 and magnets 174. Eddy current losses in stator are very low.

However the stator needs to be mounted to custom housing (FIG. 20.2). When stator is mounted to the custom housing 176 (usually made of conductive material, for example, aluminum) the Eddy current losses will occur in the custom housing.

The invented rotary axial ironless electric machine construction includes stator 178 consisted of coils 164 encapsulated in epoxy 166, stack of aluminum lamination or ceramic plate 168 and Eddy current reducer 180 (FIG. 20.3). The reducer is installed on the stator of ironless electric machine at the side opposite to magnets (or between conductive part, where eddy current losses are occurring and coils with aluminum lamination and/or ceramic). Reducer prevents Eddy current losses in the custom housing.

The Eddy current reducer for rotary axial machine is shown on FIG. 21. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 182 are divided one from another by non-magnetic spacers 184. The thickness of pieces is 0.010-1.0 mm each (or other depending on applications). The exact dimensions and quantity of pieces depend on electromechanical design and are subject for optimization.

The invented design of rotary axial ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant attraction. The Eddy current reducer finally reduces eddy current losses in custom housing 176 (FIG. 20.4).

Rotary Axial Ironless Electric Machine with Stator that Includes Coils Only.

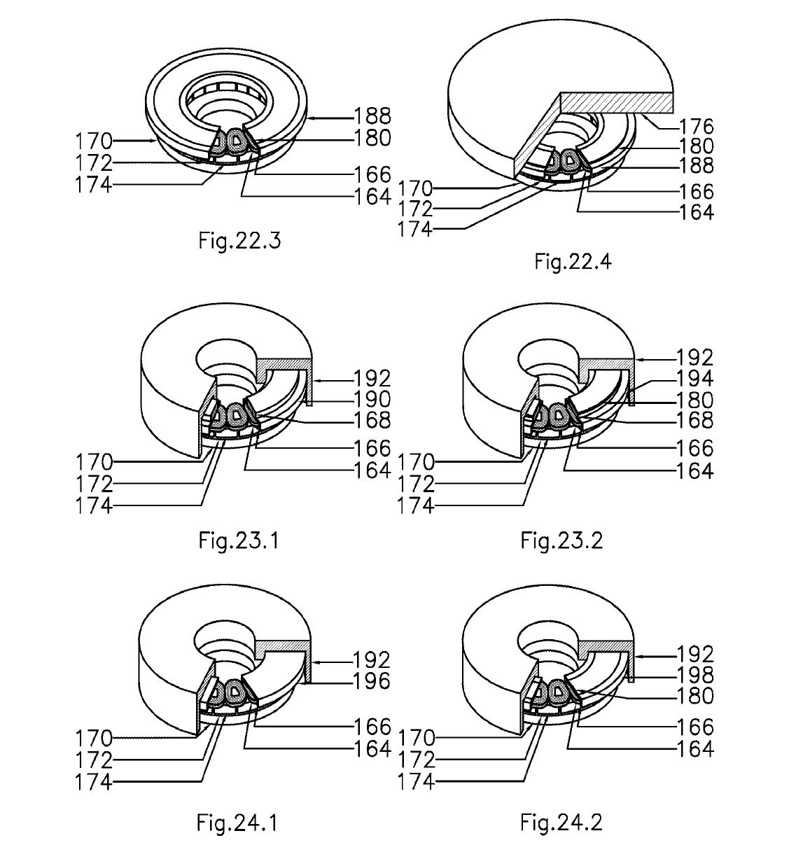

Rotary axial ironless electric machine with stator that includes coils only is shown on FIG. 22.1. Ironless stator 186 consists of coils 164 encapsulated in epoxy 166. Rotor 170 consists of magnet plate 172 and magnets 174. Eddy current losses in stator are very low.

However the stator needs to be mounted to custom housing (FIG. 22.2). When stator is mounted to the custom housing 176 (usually made of conductive material, for example, aluminum) the Eddy current losses will occur in the custom housing.

The invented rotary axial ironless electric machine construction includes stator 188 consisted of coils 164 encapsulated in epoxy 166 and Eddy current reducer 180 (FIG. 22.3). The reducer is installed on the stator of ironless electric machine at the side opposite to magnets (or between conductive part, where eddy current losses are occurring and coils). Reducer prevents Eddy current losses in the custom housing.

The Eddy current reducer for rotary axial machine is shown on FIG. 21. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 182 are divided one from another by non-magnetic spacers 184. The thickness of pieces is 0.010-1.0 mm each (or other depending on applications). The exact dimensions and quantity of pieces depend on electromechanical design and are subject for optimization.

The invented design of rotary axial ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant attraction. The Eddy current reducer finally reduces eddy current losses in custom housing 176 (FIG. 22.4).

Rotary Axial Ironless Electric Machine with Stator that Includes Coils, Aluminum Lamination or Ceramic and Aluminum Housing.

Rotary axial ironless electric machine with stator that includes coils, aluminum lamination or ceramic and aluminum housing is shown on FIG. 23.1. Ironless stator 190 consists of coils 164 encapsulated in epoxy 166, stack of aluminum laminations or ceramic 168 and aluminum housing 192. Rotor 170 consists of magnet plate 172 and magnets 174. During machine rotating the Eddy current losses will occur in the aluminum housing.

The invented rotary axial ironless electric machine construction includes stator 194 consisted of coils 164 encapsulated in epoxy 166, stack of aluminum laminations or ceramic 168, aluminum housing 192 and Eddy current reducer 180 (FIG. 23.2). The reducer is installed into the stator of ironless electric machine between aluminum housing, where eddy current losses are occurring and coils with aluminum lamination and/or ceramic. Reducer prevents Eddy current losses in the aluminum housing.

The Eddy current reducer for rotary axial machine is shown on FIG. 21. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 182 are divided one from another by non-magnetic spacers 184. The thickness of pieces is 0.010-1.0 mm each (or other depending on applications). The exact dimensions and quantity of pieces depend on electromechanical design and are subject for optimization.

The invented design of rotary axial ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant attraction. The Eddy current reducer finally reduces eddy current losses in aluminum housing 192.

Rotary Axial Ironless Electric Machine with Stator that Includes Coils and Aluminum Housing.

Rotary axial ironless electric machine with stator that includes coils and aluminum housing is shown on FIG. 24.1. Ironless stator 196 consists of coils 164 encapsulated in epoxy 166 and aluminum housing 192. Rotor 170 consists of magnet plate 172 and magnets 174. During machine rotating the Eddy current losses will occur in the aluminum housing.

The invented rotary axial ironless electric machine construction includes stator 198 consisted of coils 164 encapsulated in epoxy 166, aluminum housing 192 and Eddy current reducer 180 (FIG. 24.2). The reducer is installed into the stator of ironless electric machine between aluminum housing, where eddy current losses are occurring and coils. Reducer prevents Eddy current losses in the aluminum housing.

The Eddy current reducer for rotary axial machine is shown on FIG. 21. It is made of one or more assembled or solid pieces of oriented or non-oriented ferromagnetic material or compound (any shape, form, configuration or structure, solid or from parts, examples—sheets with or without holes, net, grid, bars, strips, etc.). Ferromagnetic pieces 182 are divided one from another by non-magnetic spacers 184. The thickness of pieces is 0.010-1.0 mm each (or other depending on applications). The exact dimensions and quantity of pieces depend on electromechanical design and are subject for optimization.

The invented design of rotary axial ironless electric machine not only reduces the module of magnetic field in conductive part but it also greatly reduces the normal component of magnetic field which creates Eddy currents (thereby the tangential component may increase but it do not create Eddy currents). Due to this feature, the very thin and magnetically saturated eddy current reducer has insignificant attraction. The Eddy current reducer finally reduces eddy current losses in aluminum housing 192.

1. An ironless electrical machine including:
magnets adapted to produce magnetic fields;
coils, said magnets, on the one hand, and said coils, on the other hand, being movable relative to one another; and
an Eddy current reducer comprising a piece comprised of ferromagnetic material and for interposition between, on the one hand, said magnets and, on the other hand, conductive material of a character in which magnetic fields induce Eddy currents.

2. A machine according to claim 1, wherein said ferromagnetic material is oriented.

3. A machine according to claim 1, wherein said piece of ferromagnetic material is 0.01 to 1.0 mm thick.

4. A machine according to claim 1, wherein said reducer is in the form of a sandwich comprising a plurality of pieces comprised of ferromagnetic material and alternating with non-magnetic spacers.

5. A linear flat ironless electric machine including:
coils;
flat magnet track with magnets placed on said magnet track and mounted so that magnetic interaction with said coils is possible; notably said coils and said magnet track are mounted so that mutual displacement from one another is possible; and
an Eddy current reducer comprising a piece comprised of ferromagnetic material and placed on said coils at the side opposite to the side where said magnet track with said magnets is placed.

6. A machine according to claim 5, wherein said ferromagnetic material is oriented.

7. A machine according to claim 5, wherein said piece of ferromagnetic material is 0.01 to 1.0 mm thick.

8. A machine according to claim 5, wherein said reducer is in the form of a sandwich comprising a plurality of pieces comprised of ferromagnetic material and alternating with non-magnetic spacers.

9. A linear tube ironless electric machine including:
coils;
tube magnet track wrapped around by said coils;
magnets placed on said magnet track and mounted so that magnetic interaction with said coils is possible: notably said coils and said magnet track are mounted so that mutual displacement from one another is possible; and
an Eddy current reducer comprising a piece comprised of ferromagnetic material and wrapping said coils.

10. A machine according to claim 9, wherein said ferromagnetic material is oriented.

11. A machine according to claim 9, wherein said piece of ferromagnetic material is 0.01 to 1.0 mm thick.

12. A machine according to claim 9, wherein said reducer is in the form of a sandwich comprising a plurality of pieces comprised of ferromagnetic material and alternating with non-magnetic spacers.

13. A linear tube ironless electric machine including:
coils;
tube magnet track wrapping around said coils;
magnets placed on said magnet track and mounted so that magnetic interaction with said coils is possible: notably said coils and said magnet track are mounted so that mutual displacement from one another is possible; and
an Eddy current reducer comprising a piece comprised of ferromagnetic material and wrapped by said coils.

14. A machine according to claim 13, wherein said ferromagnetic material is oriented.

15. A machine according to claim 13, wherein said piece of ferromagnetic material is 0.01 to 1.0 mm thick.

16. A machine according to claim 13, wherein said reducer is in the form of a sandwich comprising a plurality of pieces comprised of ferromagnetic material and alternating with non-magnetic spacers.

17. A rotary ironless electric machine including:
stator with coils;
rotor wrapped around by said stator and mounted so that rotation of said rotor relative to said stator is possible;
magnets placed on said rotor and mounted so that magnetic interaction with said coils is possible; and
an Eddy current reducer comprising a piece comprised of ferromagnetic material and wrapping said coils.

18. A machine according to claim 17, wherein said ferromagnetic material is oriented.

19. A machine according to claim 17, wherein said piece of ferromagnetic material is 0.01 to 1.0 mm thick.

20. A machine according to claim 17, wherein said reducer is in the form of a sandwich comprising a plurality of pieces comprised of ferromagnetic material and alternating with non-magnetic spacers.

21. Rotary ironless electric machine including:
stator with coils;
rotor wrapping around said stator and mounted so that rotation of said rotor relative to said stator is possible;
magnets placed on said rotor and mounted so that magnetic interaction with said coils is possible; and
an Eddy current reducer comprising a piece comprised of ferromagnetic material and wrapped by said coils.

22. A machine according to claim 21, wherein said ferromagnetic material is oriented.

23. A machine according to claim 21, wherein said piece of ferromagnetic material is 0.01 to 1.0 mm thick.

24. A machine according to claim 21, wherein said reducer is in the form of a sandwich comprising a plurality of pieces comprised of ferromagnetic material and alternating with non-magnetic spacers.

25. Rotary flat ironless electric machine including:
flat stator with coils;
flat rotor mounted so that rotation of said rotor relative to said stator is possible;
magnets placed on said rotor and mounted so that magnetic interaction with said coils is possible; and
an Eddy current reducer comprising a piece comprised of ferromagnetic material and placed on the said coils at the side opposite to the side where said rotor is placed.

26. A machine according to claim 25, wherein said ferromagnetic material is oriented.

27. A machine according to claim 25, wherein said piece of ferromagnetic material is 0.01 to 1.0 mm thick.

28. A machine according to claim 25, wherein said reducer is in the form of a sandwich comprising a plurality of pieces comprised of ferromagnetic material and alternating with non-magnetic spacers.
